(19) United States
(12) Patent Application Publication
(10) Pub. No.: US 2004/0147170 A1
(43) Pub. Date: Jul. 29, 2004

(54) Plug assembly and method of making same

(76) Inventors: Mark Greenwood, Antwerp, OH (US); Allan Heisler, Huntertown, IN (US)

Correspondence Address: Barnes & Thornburg, 600 One Summit Square, Fort Wayne, IN, 46802, US

(21) Appl. No.: 10/443,256

(22) Filed: May 22, 2003

Related U.S. Application Data
(63) Continuation of application No. 29/174,751, filed on Jan. 23, 2003.

(51) Int. Cl. H01R 13/502

(52) U.S. Cl. 439/696

(57) ABSTRACT

A plug assembly includes a sensor assembly having a plurality of conductors, a plurality of conductive pins connected to the conductors, and a body. The body is formed of at least two portions disposed adjacent the sensor assembly and conductive pins. The body portions are permanently joined to form a unitary plug body, and mechanically retain the sensor assembly and conductive pins in the assembly. The body portions are permanently (i.e., non-separably) joined by at least one of a snap fit, ultrasonic welding, friction welding, solvent welding, induction welding, adhesive welding, or the like. One aspect of the invention is a method of making a plug assembly as described above.

The present application is a Continuation of U.S. Design patent application, Ser. No. 29/174,751, filed on Jan. 23, 2003, entitled PLUG ASSEMBLY. To the extent not included below, the subject matter disclosed in that application is hereby expressly incorporated into the present application.

### FIELD OF THE INVENTION

This invention relates generally to plug assemblies and, more particularly, to sensor plug assemblies and methods of making same.

### BACKGROUND OF THE INVENTION

Plug assemblies are used in a variety of applications. In one application, a plug assembly is used to connect a sensor, such as a thermocouple, to a control circuit or instrumentation. Such assemblies typically comprise a sensor, one or more electrical conductors connected to the sensor, one or more conductive pins connected to the conductor(s), and an insulating body disposed about at least portions of the conductor(s) and pin(s).

FIG. 1 shows a partially exploded view of one known plug assembly 10. Plug assembly 10 comprises a sensor body 12 which may, for example, comprise an elongated metal tube 13. Inside metal tube 13 is a thermocouple which may be formed by joining two conductors. The proximal ends of the conductors, identified by reference numerals 14 and 16 in FIG. 1, extend from a proximal end of sensor body 12. The conductors are typically insulated from contact with sensor body 12 by a heat resistant insulator, such as magnesium oxide.

Plug assembly 10 further comprises a thermoplastic body 18 which is at least partially molded around metal pins 20 and 22. Conductors 14 and 16 are connected, such as by screws 24 and 26, to metal pins 22 and 20, respectively. After these connections are made, an additional body portion 28 is connected to body portion 18 by screws 30 and 32 to protect and isolate the junctions of conductor ends 14 and 16 and metal pins 22 and 20.

Manufacturing the assembly of FIG. 1 requires the handling and assembly of numerous parts. This method of manufacturing a plug assembly is relatively laborious and expensive.

An alternative approach to the manufacture of plug assemblies of the type shown in FIG. 1 involves welding the conductor ends to the conductive pins, followed by an overmolding process in which a thermoplastic body is molded around the weld junction. This approach involves fewer parts than the approach previously described, and may result in a more robust and unitary assembly. However, this approach involves considerable setup and changeover time if plug assemblies of various types and dimensions are required. Thus, this approach does not lend itself to the efficient manufacture of smaller lots of plug assemblies, or assemblies where the diameters of sensor bodies, connector plugs, and other dimensional features vary.

### SUMMARY OF THE INVENTION

The present invention is a plug assembly, and method of making same, which has fewer parts and requires fewer assembly operations to produce, and which is of a more unitary and robust construction, and is relatively cost efficient and inexpensive to produce in quantities large and small.

One embodiment of the invention is a plug assembly which comprises a sensor assembly having a plurality of conductors, a plurality of conductive pins connected to respective ones of the conductors, and a body formed of at least two portions disposed adjacent the sensor assembly and conductive pins so as to mechanically retain the sensor assembly and conductive pins. The body portions are non-separably joined, such as, by permanent snap fit, ultrasonic welding, friction welding, solvent welding, induction welding, or adhesive welding, to form a unitary plug body.

In certain embodiments, at least one of the body portions comprises a recess configured to receive a portion of the sensor assembly for mechanically retaining the sensor assembly in position adjacent the body. In this and other embodiments, the body portions may be molded from a plastic material. At least one of the body portions may include structures configured to mechanically retain the conductive pins and/or the sensor assembly. In certain embodiments, a plurality of projections may be formed on one or the other of the molded body portions, and a plurality of corresponding recesses may be formed in the opposing body portion. The projections engage the recesses to non-separably join the body portions to form the unitary plug body.

In one embodiment of the present invention, the sensor assembly includes a thermocouple.

In one embodiment, a method of making the plug assembly of the present invention comprises the steps of: a) providing a sensor assembly having a plurality of conductors; b) providing a plurality of conductive pins; c) connecting the conductors of the sensor assembly to respective ones of the pins to form a sensor/pin sub-assembly; d) forming a first portion of a plug body; e) disposing the sensor/pin sub-assembly adjacent the first portion of the plug body; f) forming a second portion of the plug body; and g) non-separably joining the first and second plug body portions.

The plug assembly and method of the present invention have all the advantages inherent in plugs made by a molding process. The number of parts and mechanical operations required are reduced, and reliability and operability is enhanced, when compared to prior art plugs of the type illustrated in FIG. 1. However, the plug assembly and method of the present invention offers much more flexibility in the manufacturing process, and eliminates costly setup and changeover expenses of prior art approaches which utilize a molding process.

One goal of the present invention is to provide a plug assembly (and method of making same) that meets the size, shape and performance specifications described in ASTM Standards E 1684-96 or E 1129/E 1129M-91 for miniature and standard size connectors, but which does not require removable fasteners (i.e., screws, nuts, brackets, etc.) for assembly. It is a further goal to provide such a plug assembly that may be efficiently and economically made in small lots or large, with increased manufacturing flexibility to accommodate color changes, sensor assembly configurations, pin sizes, and other variations.

Other advantages and novel features of the plug assembly and method of the present invention will become apparent from the following detailed description of the invention when considered in conjunction with the accompanying drawings.

### BRIEF DESCRIPTION OF THE DRAWINGS

The present invention will be described hereafter with reference to the attached drawings which are given as non-limiting examples only, in which:

FIG. 1 shows an exploded view of a prior art plug assembly.

FIG. 2 shows a perspective view of a plug assembly constructed in accordance with the present invention.

FIG. 3 shows a partially exploded view of the plug assembly of FIG. 2.

FIG. 4 shows a plan view of an interior of one preformed body portion 54 of the plug assembly of FIG. 2.

FIG. 4a shows a longitudinal cross section of body portion 54 taken along line AA of FIG. 4. FIG. 4b shows a longitudinal cross section of body portion 54 taken along line BB of FIG. 4.

FIG. 4c shows a transverse cross section of body portion 54 taken along line CC of FIG. 4.

FIG. 4d shows an end view of body portion 54.

FIG. 4e shows an enlarged initial portion of FIG. 4 indicated by a partial circle identified by reference numeral 92.

FIG. 4f shows an enlarged partial portion of FIG. 4c indicated by a partial circle identified by reference numeral 94.

FIG. 5 shows a plan view of an interior portion of another preformed body portion 56 of the plug assembly of FIG. 2.

FIG. 5a shows a longitudinal cross section of body portion 56 taken along line AA of FIG. 5.

FIG. 5b shows a longitudinal cross section of body portion 56 taken along line BB of FIG. 5.

FIG. 5c shows a transverse cross section of body portion 56 taken along line CC of FIG. 5.

FIG. 5d shows an end view of body portion 56.

FIG. 5e shows an enlarged partial portion of FIG. 5 indicated by a partial circle identified by reference numeral 134.

FIG. 5f shows an enlarged partial portion of FIG. 5c indicated by the partial circle identified by reference numeral 136.

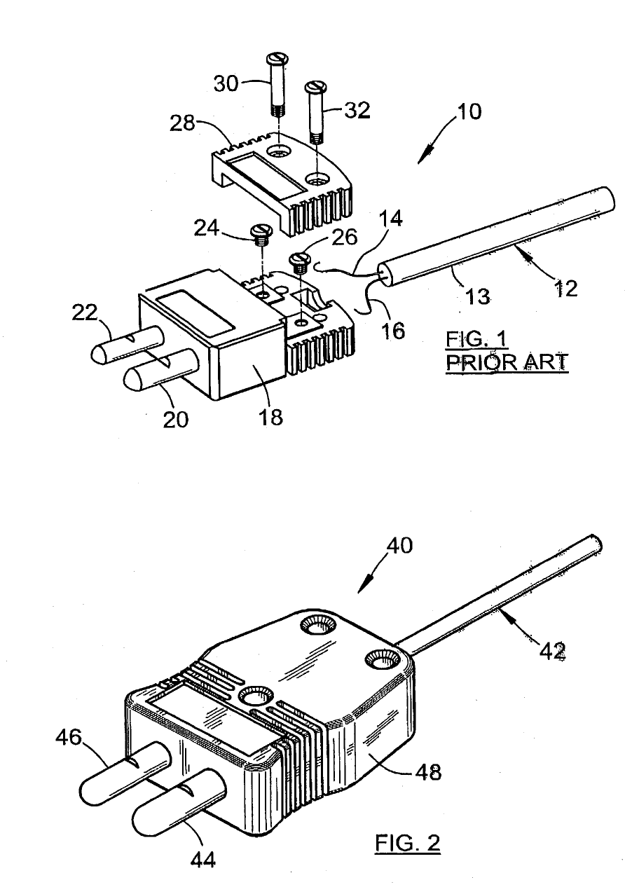

### DETAILED DESCRIPTION OF EMBODIMENTS OF THE INVENTION

The embodiments described herein are not intended to be exhaustive or to limit the invention to the precise form disclosed.

FIG. 2 shows a perspective view of a sensor plug assembly 40 constructed in accordance with the present invention. Plug assembly 40 includes a sensor assembly 42 and first and second conductive pins 44 and 46. Surrounding at least a portion of sensor assembly 42 and pins 44 and 46 is a plug body 48 formed of a non-conductive material, such as a thermoplastic.

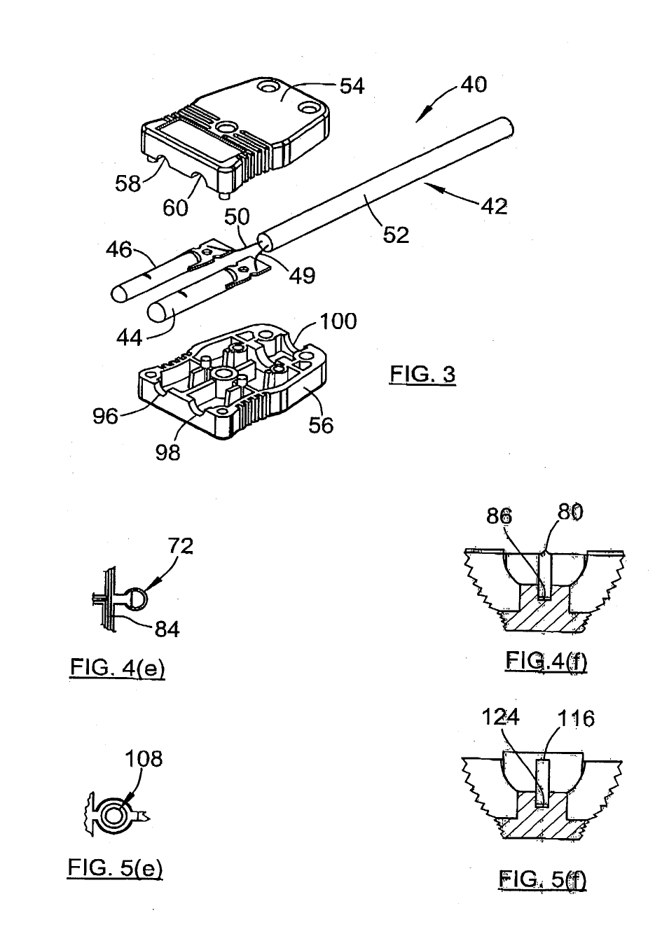

FIG. 3 shows a partially-exploded view of sensor plug assembly 40. As can be seen in FIG. 3, sensor assembly 42 includes two conductors 48 and 50. Conductors 48 and 50 may be joined at a distal end of sensor assembly 42 to form, for example, a thermocouple. Body 52 of sensor assembly 42 is formed, in one embodiment, as a metal tube. An insulating material, such as magnesium oxide, is disposed within the tube around conductors 48 and 50 to insulate the conductors from body 52 and one another.

The proximal ends of conductors 48 and 50 are connected, respectively, to conductive pins 44 and 46. In one embodiment of the present invention, these connections are made by a welding process. The result is to create a substantially-unitary sensor assembly 42 which can be easily handled in the manufacturing process, and which is reliable and resistant to vibration and damage under operational conditions.

The specific construction of the sensor assembly can vary. For example, in certain embodiments, the sensor assembly may comprise two or more insulated wires that are connected to a point distant from the plug body to a sensor element, or which are connected to each other to form a thermocouple junction. The diameter and other dimensions of the sensor assembly may also vary, as can the materials from which the sensor assemblies are constructed.

In the exploded view of FIG. 3, plug body 48 is shown as two body portions 54 and 56. In the manufacture of sensor assembly 40, portions 54 and 56 are disposed adjacent portions of sensor assembly 42 and pins 44 and 46, and are permanently joined to form plug body 48. Body portions 54 and 56 may be formed of a thermoplastic material by a molding process. Body portions 54 and 56 are permanently joined to form plug body 48 by a permanent snap fit, ultrasonic welding, friction welding, solvent welding, induction welding, adhesive bonding, or equivalent process. This results in a substantially-unitary structure having many of the same advantages and features of plug assemblies formed by using an injection molding process to form a plug body around a sensor/pin subassembly. However, body portions 54 and 56 may be “premolded” in various colors and with various dimensional configurations to accommodate a variety of sensors, pins and other features. These components can then be used as needed to manufacture sensor plug assemblies in the desired numbers having the desired features and configurations. Thus, the method of the present invention is more flexible than that in which an injection molding process is used.

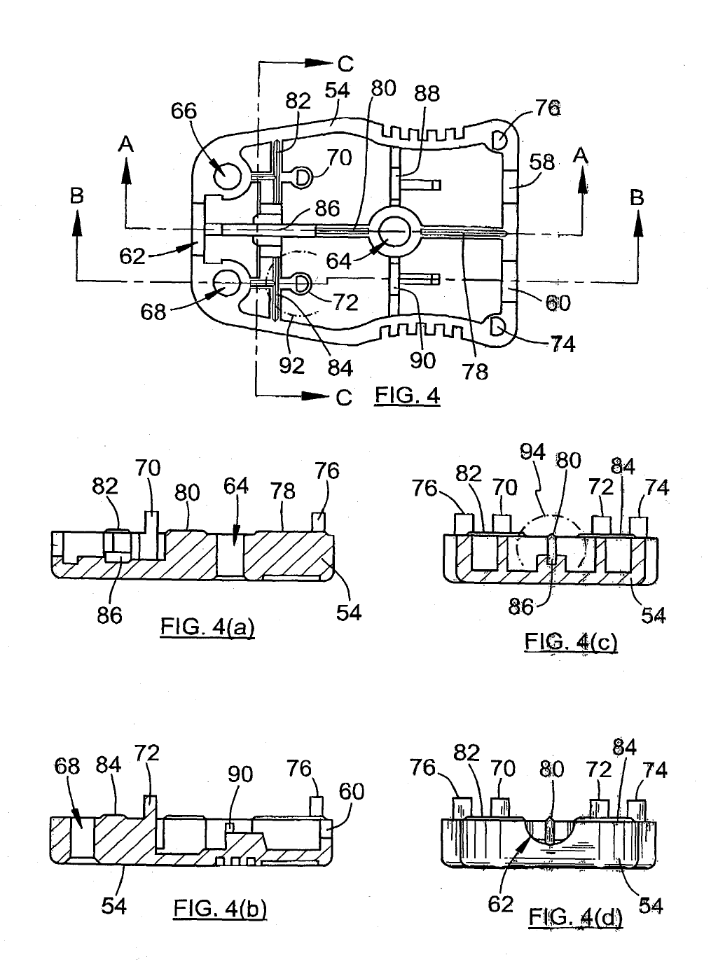

FIG. 4 shows a plan view of an interior of preformed body portion 54. Visible on one end of body portion 54 are semi-circular openings 58 and 60 which accommodate conductive pins 44 and 46, respectively. On an opposing end of body portion 54 is semi-circular opening 62 which accommodates sensor body 52. Interior features of body portion 54 include through holes 64, 66 and 68. Also shown in FIG. 4 are projections 70, 72, 74 and 76. In this particular embodiment, projections 70, 72, 74 and 76 are aligned with corresponding recesses in opposing body portion 56. The projections are slightly larger in diameter than the corresponding recesses. An ultrasonic welding technique is used to join body portions 54 and 56. In the course of that process, projections 70, 72, 74 and 76 are forced into the corresponding recesses.

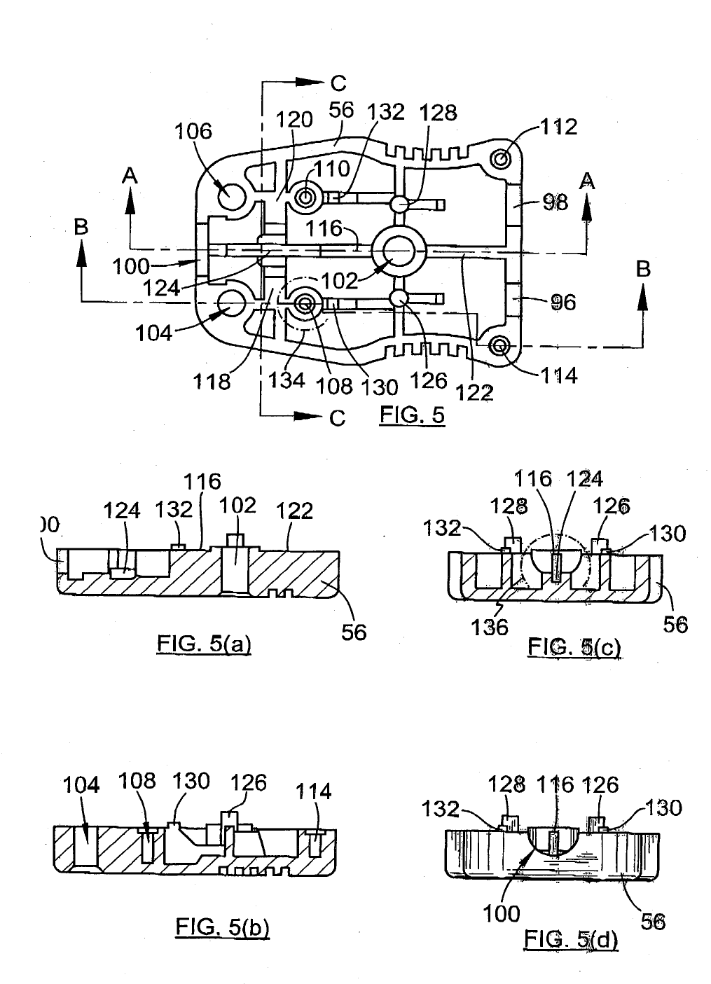

In addition to projections 70, 72, 74 and 76, additional longitudinally and transversely extending projections are disposed on one or more of the interior surfaces of body portion 54. These longitudinally and transversely extending projections are identified by reference numerals 78, 80, 82 and 84. As will be discussed and illustrated in additional detail below in connection with FIG. 5, these projections provide additional points of connection with body portion 56 in the ultrasonic welding process mentioned above.

An additional interior feature of body portion 54 is slot 86 which is generally aligned with semi-circular opening 62. Slot 86 receives a portion of sensor body 52 to help secure sensor assembly 42 against rotation after assembly is complete. Alternative or additional interior features may be provided for this purpose. On the opposing end of body portion 54, slots 88 and 90 are similarly provided to provide clearance for projections formed on body portion 56 (see FIG. 5 and the discussion below). The projections on body portion 56 interact with pins 44 and 46 to assist in securing the pins against movement following assembly.

FIG. 4a shows a longitudinal cross section of body portion 54 taken along line AA of FIG. 4. Visible in FIG. 4a are projections 70 and 76, additional longitudinally disposed projections 78, 80 and a portion of 82, semi-circular opening 62, and slot 86.

FIG. 4b shows a longitudinal cross section of body portion 54 taken along line BB of FIG. 4. Visible in FIG. 4b are semi-circular openings 60, through hole 68, projections 72 and 76, a portion of additional projection 84, and slot 90.

FIG. 4c shows a transverse cross section of body portion 54 taken along line CC of FIG. 4. Visible in FIG. 4c are projections 70, 72, 74 and 76, additional longitudinal and transverse projections 80, 82 and 84, and slot 86.

FIG. 4d shows an end view of body portion 54. Visible in FIG. 4d are semi-circular opening 62, projections 70, 72, 74 and 76, and additional longitudinal and transverse projections 80, 82 and 84.

FIG. 4e shows a partially-enlarged portion of FIG. 4 indicated by a partial circle identified by reference numeral 92. Visible in FIG. 4e are projection 72, and a portion of additional projection 84. FIG. 4f shows an enlarged partial portion of FIG. 4c indicated by the partial circle identified by reference numeral 94. Visible in FIG. 4f is an enlarged end view of additional longitudinal projection 80, and a portion of slot 86.

FIG. 5 shows a plan view of an interior of preformed body portion 56. Visible on one end of body portion 56 are semi-circular openings 96 and 98 which cooperate, respectively, with openings 58 and 60 of body portion 54 to accommodate conductive pins 44 and 46. On an opposing end of body portion 56 is semi-circular opening 100 which cooperates with semi-circular opening 62 on body portion 54 to accommodate sensor body 52. Interior features of body portion 56 include through holes 102, 104 and 106, which are axially aligned, respectively, with holes 64, 66 and 68 of body portion 54. Also shown in FIG. 5 are recesses (i.e., non-through holes) 108, 110, 112 and 114 which receive, respectively, projections 70, 72, 74 and 76 of body portion 54. As noted previously, the projections of body portion 54 are slightly larger in diameter than the corresponding recesses in body portion 56. An ultrasonic welding technique is used to join the body portions, during which the projections are forced into, and effectively welded to, the recesses.

In addition to the recesses, substantially-planer surfaces 116, 118, 120 and 122 are provided and are aligned with longitudinally and transversely-extending projections 80, 82, 84, and 78, respectively, on body portion 54. The projections on body portion 54 effectively weld to these substantially-planer surfaces to increase the area of bonding between body portions 54 and 56. In alternative embodiments, the projections, recesses and planer surfaces discussed and illustrated may be interchanged on the respective body portions, alternatively positioned, and dimensioned so as to facilitate bonding by adhesives, solvent welding, induction welding, friction welding or permanent snap fit, or other equivalent technique.

Also illustrated in FIG. 5 is a longitudinally-extending slot 124 which is similar in placement, design and function to slot 86 of body portion 54. That is, a projection or other feature on sensor body 52 is received within slot 124 to help secure sensor assembly 42 in place after assembly is complete. Alternative or additional features may be provided in body portion 56 for this purpose. On the opposing end of body portion 56, 10 projections 126 and 128 are provided. These projections extend through corresponding openings formed in respective portions of conductive pins 44 and 46. Projections 126 and 128 extend through the conductive pins and are received within slots 88 and 90 of body portion 54. In addition, projections 130 and 132 are provided to further secure the pins against movement. In the embodiment illustrated, respective ends of conductive pins 44 and 46 abut projections 130 and 132, respectively, to secure the pins against movement in the longitudinal direction.

FIG. 5a shows a longitudinal cross section of body portion 56 taken along line AA of FIG. 5. Visible in FIG. 5a are semi-circular opening 100, slot 124, substantially-planer surfaces 116 and 122, through hole 102, and projection 132.

FIG. 5b shows a longitudinal cross section of body portion 56 taken along line BB of FIG. 5. Visible in FIG. 5b are through hole 104, recess 108, projection 130, projection 126 and non-through hole 114.

FIG. 5c shows a transverse cross section of body portion 56 taken along line CC of FIG. 5. Visible in FIG. 5c are slot 124, substantially-planer surface 116 and projections 126, 128, 130 and 132.

FIG. 5d shows an end view of body portion 56. Visible in FIG. 5d are semi-circular opening 100, substantially-planer surface 116 and projections 126, 128, 130 and 132.

FIG. 5e shows an enlarged partial portion of FIG. 5 indicated by a partial circle identified by reference numeral 134. FIG. 5e shows an enlarged view of recess 108.

FIG. 5f shows an enlarged partial portion of FIG. 5c indicated by the partial circle identified by reference numeral 136. Visible in FIG. 5f is an enlarged end view of slot 124. Also visible in FIG. 5f is an end view of substantially-planer surface 116.

While this invention has been described as having exemplary embodiments, this description is not intended to be limiting. The claims are intended to cover variations, alternative uses, and adaptations utilizing the general concepts of the invention. Further, the claims are intended to cover such departures from the present disclosure as come within the known or customary practice within the art to which it pertains.

What is claimed is:

1. A method of making a plug assembly, comprising the steps of:
a) providing a sensor assembly having a plurality of conductors;
b) providing a plurality of conductive pins;
c) connecting the conductors of the sensor assembly to respective ones of the pins to form a sensor/pin sub-assembly;
d) forming a first portion of a plug body;
e) disposing the sensor/pin sub-assembly adjacent the first portion of the plug body;
f) forming a second portion of the plug body; and
g) non-separably joining the first and second plug body portions.

2. The method of claim 1, wherein the step of non-separably joining the first and second body portions includes at least one of the following: a permanent snap fit, ultrasonic welding, friction welding, solvent welding, induction welding, and adhesive bonding.

3. The method of claim 1, wherein the step of forming the first body portion comprises the step of forming on said first body portion means for mechanically retaining the sensor/pin sub-assembly adjacent the first body portion.

4. The method of claim 3, wherein the means for mechanically retaining the sensor/pin sub-assembly comprises a recess in the first body portion configured to form an interference fit with a portion of the sensor/pin sub-assembly.

5. The method of claim 3, wherein the means for mechanically retaining the sensor/pin sub-assembly comprises one or more projections on one of the sensor/pin sub-assembly and the first body portion, said one or more projections interacting with the other of said sensor/pin sub-assembly and the first body portion to retain the sensor/pin sub-assembly in position adjacent the body portion.

6. The method of claim 1, wherein the steps of forming the first and second portions of the plug body, comprise forming a plurality of projections on one of said body portions, and a corresponding plurality of cavities in the other of said body portions, said projections being received in said cavities so as to non-removably join the first and second body portions.

7. The method of claim 1, wherein the steps of forming the first and second portions of the plug body comprise molding said portions from a thermoplastic material.

8. The method of claim 1, wherein said sensor assembly comprises a thermocouple.

9. A plug assembly, comprising:
a) a sensor assembly having a plurality of conductors;
b) a plurality of conductive pins connected to respective ones of the conductors; and
c) a body formed of at least two portions disposed adjacent the sensor assembly and conductive pins so as to mechanically retain the sensor assembly and conductive pins, said body portions being non-separably joined to form a unitary plug body.

10. The assembly of claim 9, wherein the body portions are non-separably joined by at least one of the following: a permanent snap fit, ultrasonic welding, friction welding, solvent welding, induction welding and adhesive welding.

11. The assembly of claim 9, wherein at least one of said body portions comprises a recess configured to receive a portion of the sensor assembly for mechanically retaining the sensor assembly in position adjacent the body.

12. The body of claim 9, wherein said body portions are molded from a thermoplastic material.

13. The assembly of claim 12, wherein at least one of said body portions include structures configured to mechanically retain said conductive pins.

14. The assembly of claim 12, wherein at least one of said body portions include structures configured to mechanically retain said conductive pins and said sensor assembly.

15. The assembly of claim 12, further configuring a plurality of projections on at least one of said molded body portions, and a plurality of recesses on the other of said body portion, said projections engaging said recesses to non-separably join the body portions to form the unitary plug body.

16. The assembly of claim 9, wherein said sensor assembly comprises a thermocouple.
